(19) United States
(12) Patent Application Publication
(10) Pub. No.: US 2020/0151693 A1
(43) Pub. Date: May 14, 2020

(54) WWW-BASED POS WITH BOTH CONSUMER SELF-SERVICE ORDERING AND BILLING FUNCTIONS

(71) Applicant: TRUSTED SOLUTIONS CORPORATION, NEW TAIPEI CITY (TW)

(72) Inventor: KUANG HUNG CHENG, NEW TAIPEI CITY (TW)

(21) Appl. No.: 16/188,997

(22) Filed: Nov. 13, 2018

(51) Int. Cl. G06Q 20/20; G06Q 20/18; G06Q 20/08; G06Q 20/10; G06Q 30/04; G06F 17/30; G06F 21/32

(52) U.S. Cl. CPC G06Q 20/204; G06Q 20/18; G06Q 20/085; G06F 21/32; G06Q 30/04; G06F 17/30861; G06Q 20/102

(57) ABSTRACT

Disclosed is a WWW-based POS with both consumer self-service ordering and billing functions. A network connected device is connected online with the WWW-based POS of a web server, and a browser is provided as an interface to execute the WWW-based POS, and the WWW-based POS provides a cashier ordering and billing interface and a consumer self-service ordering and billing interface, so that the WWW-based POS has both functions of the cashier ordering and billing interface and the consumer self-service ordering and billing interface at the same time, and can switch from one to another according to actual requirements and conditions.

### FIELD OF THE INVENTION

The present invention relates to a point of sale (POS), and more particularly to a world wide web (WWW)-based. POS.

### BACKGROUND OF THE INVENTION

### 1. Description of the Related Art

To improve operational performance and reduce human errors, present companies with the business activities of commercial marketing and sales such as restaurants, supermarkets, physical/network online stores, logistics companies, etc. generally adopt full electronization and computerization for their distribution management and intend to achieve the effects of lowering cost, and improving management and corporate efficiency. Therefore, it is a main subject for companies to leverage the advantages of high speed and low error rate of the electronization and computerization for their management, and the way of using the POS appropriately is a key factor of success.

As to the operations of a physical store (such as a restaurant), a cashier or a counter is provided for consumers to order a meal or pay the bill, and these operations also include the process of getting or delivering the meal. At present, the point of sale (POS) is used to assist physical shopping, cashiers, and related management operations of a general manned store. Since the cashier at the counter is responsible for the work in the POS including printing an invoice or receipt, collecting payments by credit cards, or scanning barcodes, etc., therefore the POS stores can be operated and the inventory can be kept efficiently to facilitate the management of the stores.

At present, there is another assisted self-service shopping system provided for consumers to place orders and make payments, and such system is an ordering and billing system that saves labor costs.

Since the consumer self-service ordering and billing system (such as a kiosk) is an interactive multimedia self-service machine, the system generally comes with a relatively large touch screen provided for the operation by users and provides information or assists transactions, and it is an application system with independent operations which is not related to the point of sale (POS) whatsoever. The system can be operated by the cashier only and has no consumer self-service ordering and billing functions. If a store has the need for both consumer self-service ordering and billing function and cashier self-service ordering and billing function, then both of the consumer self-service ordering and billing system and the cashier ordering and billing system (POS) and their respective hardware will be required. Such operation is obviously not a perfect one, since it incurs higher costs and more complicated maintenance, management, and information integration.

In view of the drawbacks of the prior art, the inventor of the present invention provides an innovative system to overcome the drawbacks of the prior art.

### 2. Summary of the Invention

Therefore, it is a primary objective of the present invention to allow a store to be displayed from different webpages by a general network connected device without requiring the installation of any specific application program, so that the network connected device can have both functions of the traditional POS and the consumer self-service ordering and billing system to facilitate store workers and cashier to carry out the POS operations or to facilitate consumers to carry out the self-service ordering and billing operations, so as to overcome the limitation of the traditional operation requiring several different systems and to meet the requirements of the store better.

To achieve the aforementioned and other objectives, the present invention provides a WWW-based POS, comprising: a web server, having a WWW-based POS; a network connected device, including a display device and a browser, and the browser being displayed on the display device, and the network connected device being connected online with the WWW-based POS of the web server via a network, and the browser acting as an interface to execute the WWW-based POS to form a WWW-based POS; the WWW-based POS providing a cashier ordering and billing interface and a consumer self-service ordering and billing interface, so that the WWW-based POS has both functions of the cashier ordering and billing interface and the consumer self-service ordering and billing interface, and may be switched from one to another according to actual requirements and conditions.

In this embodiment, the WWW-based. POS provides a cashier ordering and billing interface and a consumer self-service ordering and billing interface, and the network connected device uses the browser as an interface to execute the WWW-based POS and provides a login system webpage, and the login system webpage has at least a login module, and the login module is provided for entering into a cashier ordering and billing interface or a consumer self-service ordering and billing interface.

In this embodiment, the login module includes but not limited to one selected from the group consisting of a login module pressing a specific key, a login module sensed by an ID sensor, login module using a different priority account, login module with a mode option, so that a store can determine an operation to be carried out by the cashier ordering and billing interface or by the consumer self-service ordering and billing interface.

In this embodiment, the login module comes with the specific key provided for a shop worker to press or click, and different specific keys have the functions of entering into the cashier ordering and billing interface and entering into the consumer self-service ordering and billing interface respectively.

In this embodiment, the login module is sensed by the ID sensor, and the ID sensor is provided by a shop worker to identify an ID, and different IDs represent whether or not there is a priority option for entering into the cashier ordering and billing interface or entering into the consumer self-service ordering and billing interface, and if the ID is verified to have the priority option to enter into the cashier ordering and billing interface or enter into the consumer self-service ordering and billing interface, then an option of entering into the cashier ordering and billing interface and an option of entering into the consumer self-service ordering and billing interface will be shown and provided for an operator to select and enter.

In this embodiment, the ID sensor is at least one selected from the group consisting of a fingerprint recognition device, a face recognition device, and an iris recognition device.

In this embodiment, the login module using a different priority account shows an account input column, and the account input column is provided for a shop worker to input a specific account, and different specific accounts represent whether or not there is a priority; option to enter into the cashier ordering and billing interface or enter into the consumer self-service ordering and billing interface, and if the ID is verified that to have a priority option to enter into the cashier ordering and billing interface or enter into the consumer self-service ordering and billing interface, then an option of entering into the cashier ordering and billing interface and entering into the consumer self-service ordering and billing interface will be shown and provided for an operator to select and enter.

In this embodiment, the login module with a mode option is an option column provided for selecting to enter into the cashier ordering and billing interface or enter into the consumer self-service ordering and billing interface.

In this embodiment, the cashier ordering and billing interface has a switching module for switching and entering into the consumer self-service ordering and billing interface.

In this embodiment, the switching module is an account input column provided for inputting a specific account to enter into the consumer self-service ordering and billing, interface.

In this embodiment, the consumer self-service ordering and billing interface comprises an account input column, the account input column provided for a shop worker to input a specific account, and different specific accounts represent switching to the cashier ordering and billing interface, or directly exiting the APP, or directly exiting the webpage.

In this embodiment, the network connected device includes but not limited to one selected from the group consisting of a mobile phone, a tablet PC, a notebook computer, and a desktop computer.

The above and other objects, features and advantages of this disclosure will become apparent from the following detailed description taken with the accompanying drawings.

### BRIEF DESCRIPTION OF THE DRAWINGS

FIG. 1 is a block diagram of the present invention.

FIG. 2 is a schematic view of selecting and switching between a cashier ordering and billing interface and consumer self-service ordering and billing interface in accordance with the present invention.

### DESCRIPTION OF THE PREFERRED EMBODIMENTS

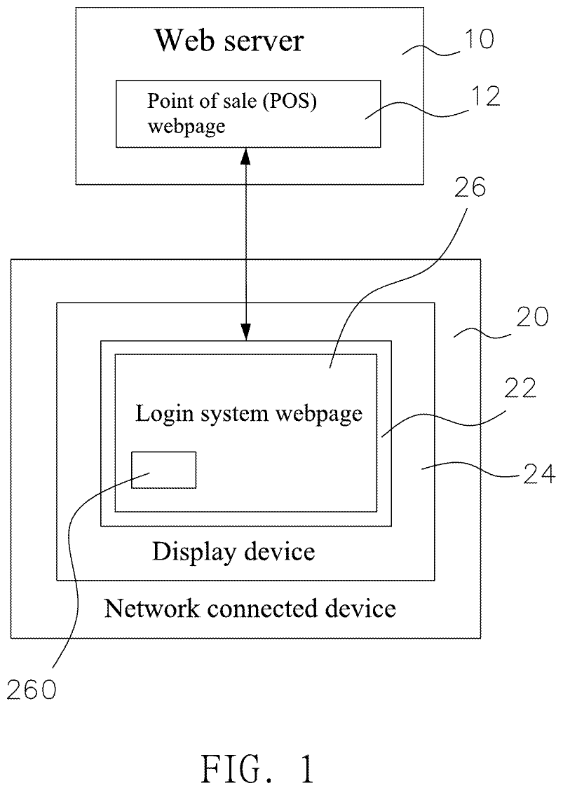

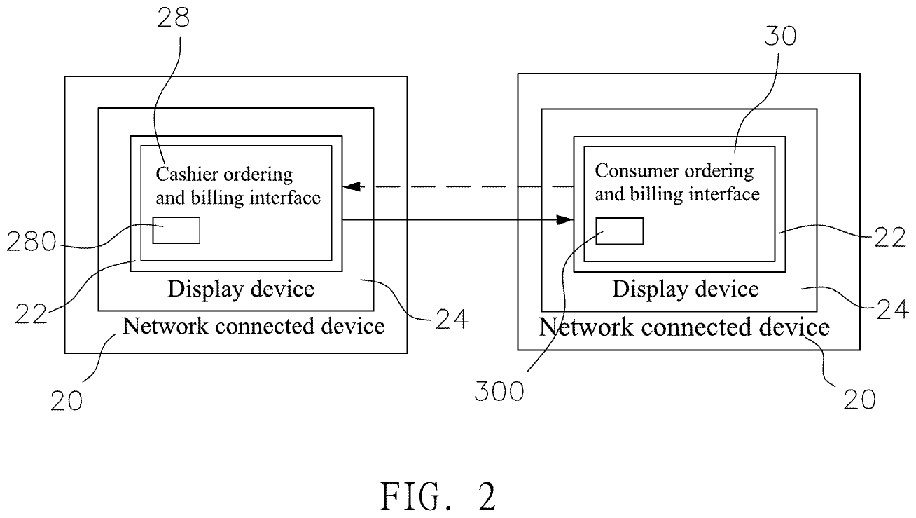

With reference to FIGS. 1 and 2 for a WWW-based POS with both consumer self-service ordering and billing functions in accordance with the present invention, the WWW-based POS comprises:

a web server 10, having a WWW-based POS 12;

a network connected device 20, including at least a display device 24 and a browser 22, and the browser 22 being displayed on the display device 24, and the network connected device 20 being connected online with the WWW-based POS 12 of the web server 10 via a network, and the browser 22 acting as an interface to execute the WWW-based POS 12; and the WWW-based POS 12 providing a cashier ordering and billing interface 28 and a consumer self-service ordering and billing interface 30, so that the WWW-based POS 12 has both functions of the cashier ordering and billing interface 28 and the consumer self-service ordering and billing interface 30 at the same time. For example, the network connected device 20 has a display device 24 configured to be facing consumers and provided for displaying a consumer self-service ordering and billing interface 30, so that the consumers may carry out the self-service functions of ordering an item, a meal, or a beverage and then paying the bill, and the network connected device further has another display device 24 configured to be facing a cashier and provided for displaying a cashier ordering and billing interface 28, so that the cashier may order an item, a meal or a beverage and then connect the consumer's payment.

The network connected device 20 uses the browser 22 as an interface to execute the WWW-based POS 12, and it may have a login system webpage 26 selectively, and the login system webpage 26 comes with at least a login module 260 provided for entering into a cashier ordering and billing interface 28 or a consumer self-service ordering and billing interface 30, so that the WWW-based POS 12 has both functions of the cashier ordering and billing interface 28 and the consumer self-service ordering and billing interface 30 at the same time.

The consumer self-service ordering and billing interface 30 may be used for a self-service function such as ordering a meal, shopping, making a reservation, or paying a bill, and the cashier ordering and billing interface 28 may be used for placing orders, collecting payments, and checking out. Of course, the cashier ordering and billing interface 28 may also include various different functional operations such as arranging a shift change, preparing, stock, making an inquiry, or related internal information, receiving cash, logging out from the system, etc.

Wherein, the network connected device 20 includes, but not limited to, one selected from the group consisting of a mobile phone, a tablet PC, a notebook computer, and a desktop computer.

Wherein, the display device 24 includes, but not limited to, a touch screen provided to facilitate users to carry out the operation intuitively.

Wherein, the login module 260 includes, but not limited to, at least one selected from the group consisting of a login module operated by pressing or clicking a specific key, a login module sensed by an ID sensor, a login module using an account of a different priority option, and a login module with a mode option, so that the store can determine an operation to be carried out by the cashier ordering and billing interface or by the consumer self-service ordering and billing interface.

Wherein, the specific key of the login module is provided for a shop worker to press or click, and different specific keys have the functions of entering into the cashier ordering and billing interface 28 and entering into the consumer self-service ordering and billing interface 30 respectively.

Wherein, the specific keys of the login module is provided for a shop worker to press or click, and different specific keys have the functions of entering into the cashier ordering and billing interface 28 and entering into the consumer self-service ordering and billing interface 30 respectively.

Wherein, the login module is sensed by an ID sensor, and the ID sensor is provided for a shop worker to identify an ID, and different IDs represent whether or not there is a priority option for entering into the cashier ordering and billing interface 28 or entering into the consumer self-service ordering and billing interface 30, and if the ID is verified to have the priority option to enter into the cashier ordering and billing interface 28 or enter into the consumer self-service ordering and billing interface 30, then an option of entering into the cashier ordering and billing interface 28 and an option of entering into the consumer self-service ordering and billing interface 30 will be shown and provided for an operator to select and enter.

Wherein, the ID sensor includes, but not limited to, one selected from the group consisting of a fingerprint recognition device, a face recognition device, and an iris recognition device.

Wherein, the login module using a different priority account shows an account input column provided for a shop worker to input a specific account, and different specific accounts represent whether or not there is a priority option to enter into the cashier ordering and billing interface 28 or the consumer self-service ordering and billing interface 30, and if the ID is verified to have the priority option to enter into the cashier ordering and billing interface 28 or enter into the consumer self-service ordering and billing interface 30, then the option of entering into the cashier ordering and billing interface 28 and the option of entering into the consumer self-service ordering and billing interface 30 will be shown and provided for an operator to select and enter.

For example, after a specific account is inputted or an ID is identified, and it is verified that the specific account or the ID has the priority option to enter into the cashier ordering and billing interface or enter into the consumer self-service ordering and billing interface, then the option of entering into the cashier ordering and billing interface 28 and the option of entering into the consumer self-service ordering and billing interface 30 will be shown and provided for the operator to select and enter, so that the network connected device 20 may enter into the cashier ordering and billing interface 28 or the consumer self-service ordering and billing interface 30 according to work requirements.

Wherein, the login module 260 is an option column provided for entering into the cashier ordering and billing interface 28 or the consumer self-service ordering and billing interface 30, so that the network connected device 20 may enter into the cashier ordering and billing interface 28 or the consumer self-service ordering and billing interface 30 according to work requirements.

With reference to FIG. 2 for switching the webpage interface of a WWW-based POS with both consumer self-service ordering and billing functions in accordance with the present invention, the cashier ordering and billing interface 28 has a switching module 280 provided for switching and entering into the consumer self-service ordering and billing interface 30. In other words, the shop worker can use the switching module 280 to switch from the cashier ordering and billing interface 28 to the consumer self-service ordering and billing interface 30 anytime as needed, while operating the cashier ordering and billing interface 28. For example, when a store cashier takes off, the consumer self-service ordering and billing interface 30 is switched and then the display device 24 turned into a direction facing consumers, so that the consumers may carry out the ordering and billing functions through the consumer self-service ordering and billing interface 30.

Wherein, the switching module 280 is an account input column provided for inputting a specific account to enter into the consumer self-service ordering and billing interface 30.

The consumer self-service ordering and billing interface 30 comprises an account input column 300 provided for a shop worker to input a specific account, and different specific accounts represent switching to the cashier ordering and billing interface 28, or directly exiting the APP 22, or logging out from the webpage. As to consumers, they do not know any specific account, so that the consumers can be restricted from switching to the cashier ordering and billing interface 28, or directly exiting the webpage, or directly logging out from the webpage in order to prevent ruining the continual use or operation of the self-service ordering and billing functions by the next consumer.

The consumer self-service ordering and billing interface 30 may further provide store information, marketing information, or small game software, etc. The WWW-based POS not just saves labor costs only, but also provides the marketing and advertising functions.

In an application of the WWW-based POS with both consumer self-service ordering and billing functions in accordance with the present invention, the login module 260 of the login system interface 26 is provided to enter into the cashier ordering and billing interface 28 or the consumer self-service ordering and billing interface 30. When the logon module 260 enters into the cashier ordering and billing interface, it is used as the POS. For example, the POS may be used for the function of placing orders, collecting payments, and checking out, and the POS may include the functions of arranging shift changes, preparing stocks, making an inquiry, compiling related internal information of the store, receiving cash, and logging out from the system. When there is no staff in the store (for example, when the cashier leaves the counter or takes off), the switching module 280 may be used to enter into the consumer self-service ordering and billing interface 30 which is provided for consumers to carry out the ordering and billing functions on their own. When the login system interface 26 enters into the consumer self-service ordering and billing interface 30 through the login module 260, the consumers are allowed to carry out the ordering and billing function on their own in an unmanned store.

Therefore, the stores using the WWW-based POS having both consumer self-service ordering and billing function may have both consumer self-service ordering and billing and cashier ordering and billing modes in a single system at the same time. Further, the system service method can be adjusted anytime according to different using hardware or different schedules of shop workers. In addition, the login system webpage 26 is a basic WWW-based. POS 12, and the web server 10 of the WWW-based POS 12 may switch its ordering and billing method and process according to the store's requirements, and different interfaces (such as the cashier ordering and billing interface 28, and the consumer self-service ordering and billing interface 30) provide different user interfaces, so that both accounting and inventory can be managed by the system synchronously.

By the WWW-based POS having both consumer self-service ordering and billing functions in accordance with the present invention, the login module 260 of the login system webpage 26 can be used to operate an interface to enter into the cashier ordering and billing interface 28 or the consumer self-service ordering and billing interface 30, so that the store can use a single system to provide the functions of both of the traditional POS and the consumer self-service ordering and billing system, as to facilitate store workers and cashiers to carry out the work operations or to facilitate consumers to carry out their self-service ordering and billing operations. This invention improves over the traditional standalone system with the limitation on the operation of the POS and the consumer self-service ordering and billing system, and thus the invention can meet the requirements of the stores better.

In summation of the description above, the present invention improves over the prior art and complies with patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A WWW-based POS with both consumer self-service ordering and billing functions, comprising:
a web server, having a WWW-based POS;
a network connected device, including a display device and a browser, and the browser being displayed on the display device, and the network connected device being connected online with the WWW-based POS of the web server via a network, and the browser acting as an interface to execute the WWW-based POS to form a WWW-based POS;
the WWW-based POS providing a cashier ordering and billing interface and a consumer self-service ordering and billing interface, so that the WWW-based POS has both functions of the cashier ordering and billing interface and the consumer self-service ordering and billing interface, and may be switched from one to another according to actual requirements and conditions.

2. The WWW-based POS with both consumer self-service ordering and billing functions according to claim 1, wherein the WWW-based POS provides a cashier ordering and billing interface and a consumer self-service ordering and billing interface, and the network connected device uses the browser as an interface to execute the WWW-based POS and provides a login system webpage, and the login system webpage has at least a login module, and the login module is provided for entering into a cashier ordering and billing interface or a consumer self-service ordering and billing interface.

3. The WWW-based POS with both consumer self-service ordering and billing functions according to claim 2, wherein the login module is at least one selected from the group consisting of a login module operated by pressing or clicking a specific key, a login module operated by sensing through an ID sensor, a login module using an account of a different priority option, and a login module with a mode option, so that the store can determine an operation to be carried out by the cashier ordering and billing interface or by the consumer self-service ordering and billing interface.

4. The WWW-based POS with both consumer self-service ordering and billing functions according to claim 3, wherein the login module operated by pressing or clicking a specific key, the specific key provided for a shop worker to press or click, and different specific keys have the functions of entering into the cashier ordering and billing interface and entering into the consumer self-service ordering and billing interface respectively.

5. The WWW-based POS with both consumer self-service ordering and billing functions according to claim 3, wherein the login module operated by sensing through an ID sensor, the ID sensor is provided by a shop worker to identify an ID, and different IDs represent whether or not there is a priority option for entering into the cashier ordering and billing interface or entering into the consumer self-service ordering and billing interface, and if the ID is verified to have the priority option to enter into the cashier ordering and billing interface or enter into the consumer self-service ordering and billing interface, then an option of entering into the cashier ordering and billing interface and an option of entering into the consumer self-service ordering and billing interface will be shown and provided for an operator to select and enter.

6. The WWW-based POS with both consumer self-service ordering and billing functions according to claim 5, wherein the ID sensor is one selected from the group consisting of a fingerprint recognition device, a face recognition device, and an iris recognition device.

7. The WWW-based POS with both consumer self-service ordering and billing functions according to claim 3, wherein the login module using an account of a different priority shows an account input column, and the account input column is provided for a shop worker to input a specific account, and different specific accounts represent whether or not there is a priority option to enter into the cashier ordering and billing interface or enter into the consumer self-service ordering and billing interface, and if the ID is verified that to have a priority option to enter into the cashier ordering and billing interface or enter into the consumer self-service ordering and billing interface, then an option of entering into the cashier ordering and billing interface and entering into the consumer self-service ordering and billing interface will be shown and provided for an operator to select and enter.

8. The WWW-based POS with both consumer self-service ordering and billing functions according to claim 3, wherein the login module with a mode option is an option column provided for selecting to enter into the cashier ordering and billing interface or enter into the consumer self-service ordering and billing interface.

9. The WWW-based POS with both consumer self-service ordering and billing functions according to claim 1, wherein the cashier ordering and billing interface has a switching module for switching and entering into the consumer self-service ordering and billing interface.

10. The WWW-based POS with both consumer self-service ordering and billing functions according to claim 4, wherein the switching module is an account input column provided for inputting a specific account to enter into the consumer self-service ordering and billing interface.

11. The WWW-based POS with both consumer self-service ordering and billing functions according to claim 1, wherein the consumer self-service ordering and billing interface comprises an account input column, the account input column provided for a shop worker to input a specific account, and different specific accounts represent switching to the cashier ordering and billing interface, or directly exiting the APP, or directly exiting the webpage.

12. The WWW-based POS with both consumer self-service ordering and billing functions according to claim I, wherein the network connected device is one selected from the group consisting of a mobile phone, a tablet PC, a notebook computer, and a desktop computer.
